(19) United States
(12) Patent Application Publication
(10) Pub. No.: US 2010/0159431 A1
(43) Pub. Date: Jun. 24, 2010

(54) ELECTRONIC AUDIO PLAYING APPARATUS WITH AN INTERACTIVE FUNCTION AND METHOD THEREOF

(75) Inventors: HSIAO-CHUNG CHOU, Tu-Cheng (TW); LI-ZHANG HUANG, Tu-Cheng (TW); CHUAN-HONG WANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/436,758

(22) Filed: May 6, 2009

(30) Foreign Application Priority Data
Dec. 18, 2008 (CN) 200810306365.1

(51) Int. Cl. G09B 5/04

(52) U.S. Cl. 434/319

(57) ABSTRACT

An electronic audio playing apparatus with an interactive function is provided. An interactive file stored in a data storage of the electronic audio playing apparatus comprises time and sequence data, a main audio, and at least one question audio. The time and sequence data is for controlling the playing time and sequence data of the main audio and the question audios. After each question audio is played, the apparatus receives answers from the user, compares the answer from the user with a right answer, and controls an action performing device to implement an action according to the comparison result.

### RELATED APPLICATIONS

This application is related to a commonly owned, co-pending U.S. patent application, with docket no. US18551, filed concurrently herewith and entitled “ELECTRONIC AUDIO PLAYING APPARATUS WITH AN INTERACTIVE FUNCTION AND METHOD THEREOF”, which is incorporated herein in its entirety by reference.

### BACKGROUND

1. Technical Field

The present disclosure relates to an electronic audio playing apparatus with an interactive function and a method thereof.

2. Description of Related Art

Current audio file formats commonly used are, among others, AAC, AC-3, ATRAC3plus, MP3, and WMA9. Users can only play such files and cannot interact with them.

Therefore, what is needed is an electronic audio playing apparatus with interactive function for audio files and a method for such an apparatus to achieve the function.

### BRIEF DESCRIPTION OF THE DRAWINGS

The components of the drawings are not necessarily drawn to scale, the emphasis instead being placed upon clearly illustrating the principles of the electronic audio playing apparatus. Moreover, in the drawings, like reference numerals designate corresponding parts throughout several views.

FIG. 1 is a block diagram of an electronic audio playing apparatus with an interactive function in accordance with a first exemplary embodiment.

FIG. 2 is a schematic diagram of a first exemplary data structure of an interactive file stored in the electronic audio playing apparatus of FIG. 1.

FIG. 3 is a schematic diagram of a second exemplary data structure of the interactive file.

FIG. 4 is a flowchart of an interactive method applied on the electronic audio playing apparatus of FIG. 1, in accordance with an exemplary embodiment.

### DETAILED DESCRIPTION

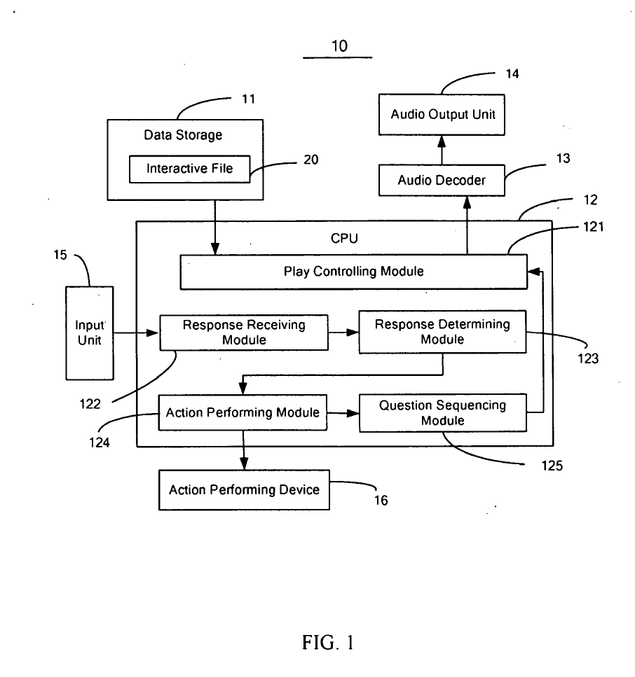

FIG. 1 is a block diagram of an electronic audio playing apparatus with an interactive function (hereafter “the apparatus”) in accordance with a first exemplary embodiment. The apparatus 10 can interact with users. For example, when the apparatus 10 is configured for using in an educational environment it can automatically play audio files that are questions for the user to answer after the user has listened to some study materials. When the apparatus 10 finishes outputting an audio file, the apparatus 10 generates and outputs a question to users.

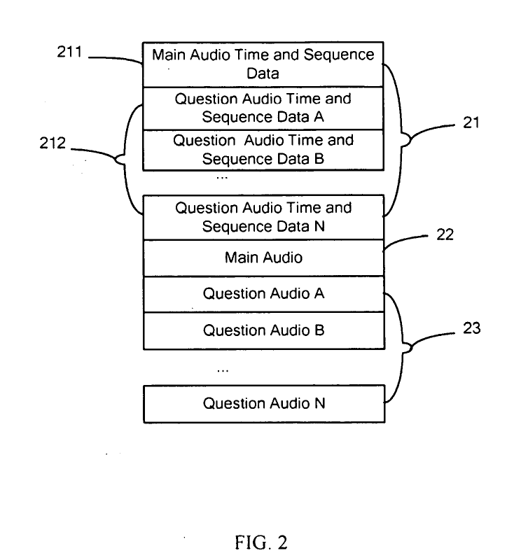

The apparatus 10 includes a data storage 11, a central processing unit (CPU) 12, an audio decoder 13, an audio output unit 14, an input unit 15, and an action performing device 16. The data storage 11 stores at least one interactive file. Referring to FIG. 2, each interactive file 20 includes time and sequence data 21, a main audio 22, and at least one question audios 23. Content of the main audio 22 is, for example, a story, a song, an article or other audio content. The at least one question audio 23 is a question regarding content of the main audio 22.

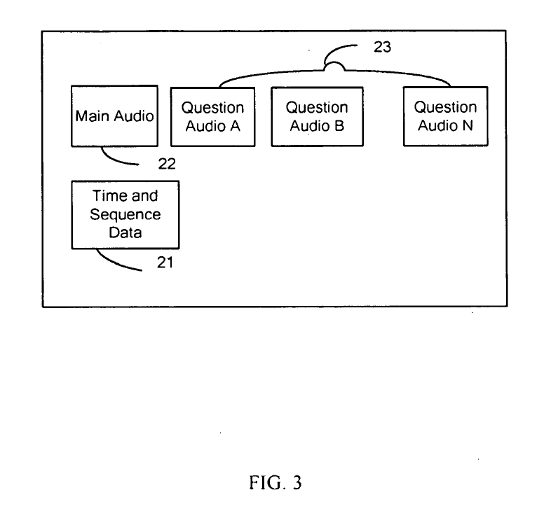

In another embodiment, the time and sequence data 21, the main audio 22, and each of the question audios 23 are stored in the data storage 11 as separate files, as shown in FIG. 3.

The time and sequence data 21 is a kind of metadata that describes the structure of the interactive file 20. The time and sequence data includes a main audio time and sequence data 211 and a plurality of question audio time and sequence data 212. The main audio time and sequence data 211 includes address of the main audio 22.

Each of the question audio time and sequence data 212 is associated with a question audio 23, and includes information related to the associated question audio 23. For example, the question audio time and sequence data 212 includes address of the associated question audio 23 and a right answer of the associated question audio 23.

The CPU 12 includes a play controlling module 121, a response receiving module 126, a response determining module 123, an action performing module 124, and a question sequencing module 125.

The play controlling module 121 is for accessing the time and sequence data 21 of the interactive file 20, and further accessing the main audio 22 according to the address included in the main audio time and sequence data 211, and accessing the question audios 23 according to the addresses included in the question audio time and sequence data 212. After being decoded by the decoder 13, the accessed main audio 22 and question audio 23 is output by the audio output unit 14.

The response receiving module 122 is for receiving and recognizing input signals generated by the input unit 15 and thus to determine answers from the user. The input unit 15 can be buttons, touch sensors, or an audio input device such as a microphone. In this exemplary embodiment, the input unit 15 is buttons. Accordingly, the user can input different answers by pressing different buttons. For example, there can be four buttons A-D for inputting answers A-D.

The response determining module 124 is for comparing the answer from the user with the right answer included in the question audio time and sequence data 212 to determine whether the answer from the user is right or wrong.

The question sequencing module 125 is for determining whether the question audio currently played is the last one. If the question audio 23 currently played is the last one, the question sequencing module 125 ends playing the interactive file 20. If the question audio 23 currently played is not the last one, the question sequencing module 125 notifies the play controlling module 121 to access the question audio time and sequence data 212 of the next question audio 23. In this exemplary embodiment, the question sequencing module 125 determines whether the question audio currently played is the last one by determining whether the number of the question audio 23 currently played is equal to the number of the question audios, and the question sequencing module 125 obtains the question audio time and sequence data 212 of the next audio 23 according to the sequence that the question audio time and sequence data 212 is stored in the data storage 11.

In another exemplary embodiment, the question audio time and sequence data 212 further includes the address of the question audio time and sequence data of the next question audio 23. The question sequencing module 125 determines whether the question audio currently played is the last one by determining whether the address of the question audio time and sequence data 212 of the next question audio 23 is a predetermined value, and the question sequencing module 125 obtains the question audio time and sequence data 212 of the next audio 23 according to the address of the question audio time and sequence data of the next question audio 23.

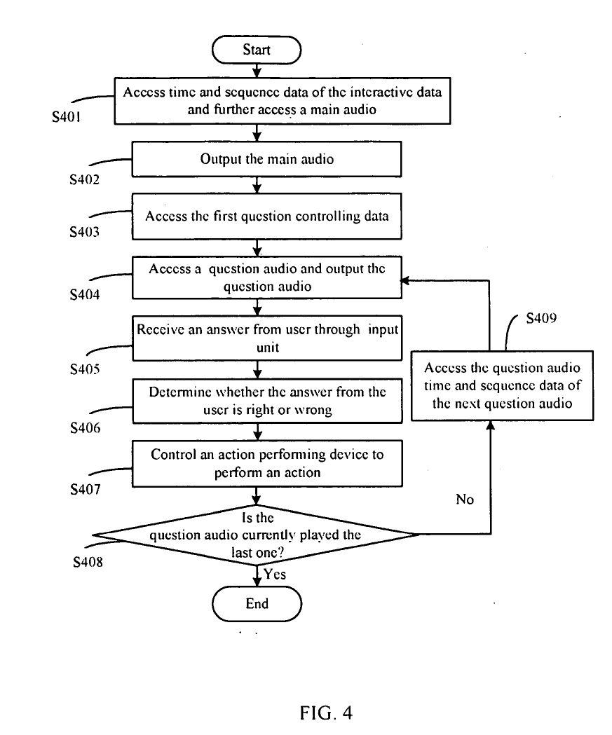

FIG. 4 is a flowchart of an interactive method applied on the electronic audio playing apparatus of FIG. 1. In step S401, the play controlling module 121 accesses the time and sequence data 21 of the interactive file 20, and further accesses the main audio 22 according to the address of the main audio 22 included in the main audio time and sequence data 211.

In step S402, after decoded by the decoder 13, the accessed main audio 22 is output through the audio output unit 14.

In step S403, the play controlling module 121 accesses the first question audio time and sequence data 212 from the time and sequence data 21.

In step S404, the play controlling module 121 accesses the question audio 23 according to the address included in the accessed question audio time and sequence data 212, and outputs the accessed question audio 23 through the audio output unit 14 after the accessed question audio 23 is decoded by the decoder 13.

In step S405, The response receiving module 122 receives and recognizes input signals generated by the input unit 15 and thus to determine answers from the user.

In step S406, the response determining module 124 compares the answer from the user with the right answer included in the question audio time and sequence data 212 to determine whether the answer from the user is right or wrong.

In step S407, the action performing module 124 controls the action performing device 16 to perform an action corresponding to the comparison result.

In step S408, the question sequencing module 125 determines whether the question audio 23 currently played is the last one.

If the question audio 23 currently played is not the last one, in step S409, the question sequencing module 125 notifies the play controlling module 121 to access the next question audio time and sequence data 212, and the procedure goes to step S504.

Although the present invention has been specifically described on the basis of preferred embodiments, the invention is not to be construed as being limited thereto. Various changes or modifications may be made to the embodiment without departing from the scope and spirit of the invention.

What is claimed is:

1. An electronic audio playing apparatus with an interactive function, comprising:
a data storage for storing at least an interactive file, wherein the interactive file comprises time and sequence data, a main audio, and at least one question audio, the time and sequence data comprises a main audio time and sequence data and a plurality of question audio time and sequence data each of which is associated with one of the at leas one question audio, the question audio time and sequence data comprises address of associated question audio and a right answer of the question audio;
a play controlling module for accessing the time and sequence data of the interactive file, and further accessing the main audio according to the address of the main audio comprised in the main audio time and sequence data, and accessing the question audio according to the address of the question audio comprised in the question audio time and sequence data, outputting the accessed main audio and question audio through an audio output unit;
a response receiving module for receiving and recognizing input signals generated by an input unit and thus to determine answers from the user;
a response determining module for comparing the answer from the user with the right answer stored in the question audio time and sequence data to determine whether the answer from the user is right or wrong.
a question sequencing module for determining whether the question audio currently played is the last one, and notifying the play controlling module to access the question audio time and sequence data of the next question audio if the question audio currently played is not the last one.

2. The apparatus as described in claim 1, wherein the question sequencing module determines whether the question audio currently played is the last one by determining whether the number of the question audio currently played is equal to the number of the question audios.

3. The apparatus as described in claim 2, wherein the question sequencing module obtains the question audio time and sequence data of the next audio according to the sequence that the question audio time and sequence data is stored in the data storage.

4. The apparatus as described in claim 1, wherein the question audio time and sequence data further stores the address of the question audio time and sequence data of the next question audio, the question sequencing module determines whether the question audio currently played is the last one by determining whether the address of the question audio time and sequence data of the next question audio is a predetermined value.

5. The apparatus as described in claim 4, wherein the question sequencing module obtains the question audio time and sequence data of the next audio according to the address of the question audio time and sequence data of the next question audio.

6. The interactive method as described in claim 1, wherein the time and sequence data, the main audio, and a plurality of question audios are stored in the data storage as separate files, which are the at least one interactive file.

7. An interactive method applied on an electronic audio playing apparatus, comprising:
(a) providing a data storage for storing at least an interactive file, wherein the interactive file comprises time and sequence data, a main audio, and at least one question audio, the time and sequence data comprises a main audio time and sequence data and a plurality of question audio time and sequence data each of which is associated with one question audio, the question audio time and sequence data comprises address of associate question audio and a right answer of the question audio;
(b) accessing a time and sequence data of the interactive file;
(c) accessing the main audio according to the address of the main audio which comprised in the main audio time and sequence data and outputting the accessed main audio through an audio output unit;
(d) accessing the first question audio time and sequence data from the time and sequence data;
(e) accessing the question audio according to the address of the question audio which stored in the question audio time and sequence data and outputting the accessed question audio through the audio output unit;
(f) receiving and recognizing input signals generated by an input unit and thus to determine answers from the user;
(g) comparing the answer from the user with the right answer stored in the question audio time and sequence data to determine whether the answer from the user is right or wrong;
(h) determining whether the question audio currently played is the last one;
(i) notifying the play controlling module to access the question audio time and sequence data of the next question audio if the question audio currently played is not the last one.

8. The interactive method as described in claim 7, wherein, in step (h), determining whether the question audio currently played is the last one is by determining whether the number of the question audio currently played is equal to the number of the question audios.

9. The interactive method as described in claim 8, wherein, in step (i), obtaining the question audio time and sequence data of the next question audio is according to the sequence that the question audio time and sequence data is stored in the data storage.

10. The interactive method as described in claim 7, wherein the question audio time and sequence data further stores the address of the question audio time and sequence data of the next question audio, in step (h), determining whether the question audio currently played is the last one is by determining whether the address of the question audio time and sequence data of the next question audio is a predetermined value.

11. The interactive method as described in claim 9, wherein, in step (i), obtaining the question audio time and sequence data of the next question audio is according to the address of the question audio time and sequence data of the next question audio.

12. The interactive method as described in claim 7, wherein the time and sequence data, the main audio, and a plurality of question audios are stored in the data storage as separate files, which are the at least one interactive file.
